(19) United States
(12) Patent Application Publication
(10) Pub. No.: US 2016/0084793 A1
(43) Pub. Date: Mar. 24, 2016

(54) ELECTRODE REACTION AREA TESTING METHOD OF BIOSENSOR TEST STRIP

(71) Applicant: BROADMASTER BIOTECH CORP., ZHONGLI CITY (TW)

(72) Inventors: YI LUNG CHEN, ZHONGLI CITY (TW); CHIEN HUNG LAI, ZHONGLI CITY (TW); YA SIAN LIN, ZHONGLI CITY (TW); FANG YI JIANG, ZHONGLI CITY (TW); CHIH CHUN YU, ZHONGLI CITY (TW); YI CHUNG CHANG, ZHONGLI CITY (TW)

(21) Appl. No.: 14/490,323

(22) Filed: Sep. 18, 2014

(51) Int. Cl. G01N 27/327

(52) U.S. Cl. CPC G01N 27/3274; G01N 27/3272

(57) ABSTRACT

An electrode reaction area testing method of biosensor test strip includes: (1) preparing a semi-finished or finished test strip product having at least one sensing window corresponding to an electrode reaction area; a plural electrodes exposed from the electrode reaction area; (2) detecting the electrode reaction current of the electrode reaction area to obtain a first electrode reaction current and a third electrode reaction current; (3) calculating a current ratio of the first electrode reaction current to the third electrode reaction current; (4) determining the current ratio; (5) completing the detection of the electrode reaction area to determine whether the semi-finished or finished test strip product is good or defective, so as to test the accuracy of the separating plate attaching position or the insulating position and the applicability of the electrode reaction area in the manufacture of the test strip.

### FIELD OF THE INVENTION

The presented invention relates to a testing method of a biosensor test strip, and more particularly to an electrode reaction area testing method of a biosensor test strip that tests the accuracy of an attaching position or an insulating position of a separating plate in the manufacture of the biosensor test strip, so that an electrode reaction area of the biosensor test strip can be controlled within a fixed conduction operation range.

### BACKGROUND OF THE INVENTION

Nowadays, people pay more attention to individual physical health, particularly to chronic diseases caused by high blood sugar, high pressure, and high cholesterol, and to establish a habit of preventing, caring and treating these diseases in daily life, thus it common for people to measure physiological data for the prevention and treatment purposes. In present ways of measuring physiological data, a biological test strip is used for carrying a sample, and a testing device (such as a blood glucose meter) is used for testing the glucose concentration or cholesterol concentration of the sample through an electrochemical sensor system. The system generally tests the analyte in the sample by an enzymatic amperometric method, which a oxidation voltage is applied on the strip for generating an electrochemical current (or a sensing current), so as to generate the so-called Cottrell current. The concentration of the analyte in the same is calculated according to the Cottrell equation. In the Cottrell equation i(t)=K·n·F·A·C·D^{0.5}·t^{-0.5} where i is the instantaneous value of a sensing current; K is a constant; n is the number of transmitted electrons; F is the Faraday constant; A is the surface area of an electrode; C is the concentration of an analyte in a sample; D is the diffusion coefficient of a reagent; and t is a specific time after applying a predetermined voltage to an electrode.

The conventional test strip includes a substrate and a separating plate, and a plurality of electrodes disposed on the substrate, where the separating plate is attached on and includes a sensing window. The separating plate is cover onto the plurality of electrodes on the substrate, and the electrodes are exposed from the sensing window. When a sample is introduced into the sensing window, and the testing instrument is turned on to generate an electronic signal and produce a test result.

When the separating plate is attached onto the substrate, the area of the plurality of electrodes exposed from the sensing window is an electrode reaction area provided for carrying the sample, but the exposed electrode reaction area may have a deviation issue when attaching the separating plate. In other words, a detective product with the electrode reaction area incompliant with the required testing standards may be produced, such as the problems of the electrode reaction area as reflected in the Cottrell equation which cause errors in the biological test data. There is no testing method for testing whether the separating plate attaching position is correct, whether the electrode reaction area is complaint with the required standards, or whether the electrode reaction area falls within the scope of a good product so far, and thus the prior art causes troubles while using or testing the product and requires improvements. Therefore, it is an important research and development subject for related manufacturers to overcome the drawbacks and problems of unable to control the reacting electrode area of a test strip when the test strip is manufactured.

In view of the drawbacks with regard to the manufacture and application of the conventional test strip and the fact of unable to control the testing of the electrode reaction area of the conventional test strip, the inventor of the presented invention conducted extensive researches and developed a test strip, which the electrode reaction area can be tested easily to control and provide an electrode reaction area testing method of the biosensor test strip in accordance with the present invention to control and improve the quality of the product.

### SUMMARY OF THE INVENTION

Therefore, it is a primary objective of the present invention to provide an electrode reaction area testing method of a biosensor test strip, such that when the test strip is manufactured and tested, the accuracy of the separating plate attaching position or insulating position, and the applicability of the electrode reaction area can be tested to determine whether the manufacture of the test strip falls within the range of a good product, so as to improve the quality of the test strip product and the accuracy of measuring the physiological data.

To achieve the aforementioned objectives, the present invention provides an electrode reaction area testing method of a biosensor test strip comprising the following steps:

1. Prepare a semi-finished or finished test strip product, wherein the semi-finished or finished test strip product comprises a substrate and a separating plate; the separating plate has a sensing window; the substrate has a first electrode, a second electrode and a third electrode disposed on a side of the sensing window and sequentially arranged from the outside to the inside; an end of the first electrode proximate to the sensing window is a first reacting electrode, an end of the second electrode proximate to the sensing window is a second reacting electrode, an end of the third electrode proximate to the sensing window is a third reacting electrode.

2. Cover the separating plate onto the first electrode, the second electrode and the third electrode, aligning the sensing window with the first reacting electrode, the second reacting electrode, and the third reacting electrode, wherein the first reacting electrode, the second reacting electrode and the third reacting electrode have a partial area exposed from the sensing window; this partial area of the first reacting electrode exposed from the sensing window is a first electrode reaction area, the partial area of the second reacting electrode exposed from the sensing window is a second electrode reaction area, and the partial area of the third reacting electrode exposed from the sensing window is a third electrode reaction area.

3. Introduce a sample into the semi-finished or finished test strip product, and apply a voltage, such that the first electrode reaction area generates a first electrode reaction current, and the third electrode reaction area generates a third electrode reaction current; detect and obtain the first electrode reaction current and the third electrode reaction current.

4. Calculate a current ratio of the first electrode reaction current to the third electrode reaction current.

5. Determine the current ratio by determining whether the current ratio falls within a predetermined numeric value range. If yes, then the electrode reaction area of the semi-finished or finished test strip product is good, or else the electrode reaction area of the semi-finished or finished test strip product is defective.

6. Complete the test of the electrode reaction area of the semi-finished or finished test strip product to determine whether the test strip is a good product or a defective product.

In the aforementioned testing method, the predetermined numeric value range is set by experiment statistics such that when the current ratio falls within the numeric value range, the first electrode reaction area and the third electrode reaction area are correct.

The presented invention will become clearer in light of the following detailed description of an illustrative embodiment of this invention described in connection with the drawings.

### BRIEF DESCRIPTION OF THE DRAWINGS

FIG. 1 is an exploded view of a biosensor test strip of the present invention;

FIG. 2 is a perspective view of a biosensor test strip of the present invention;

FIG. 3 is a top view of a semi-finished product of a biosensor test strip of the present invention;

FIG. 3A is a partial blow-up view of a semi-finished product of a biosensor test strip of the present invention;

FIG. 3B-3E are schematic views of inspecting a defective product by different methods respectively;

FIG. 4 is a first flow chart of a testing method of a biosensor test strip of the present invention; and

FIG. 5 is a second flow chart of a testing method of a biosensor test strip of the present invention.

### DESCRIPTION OF THE PREFERRED EMBODIMENTS

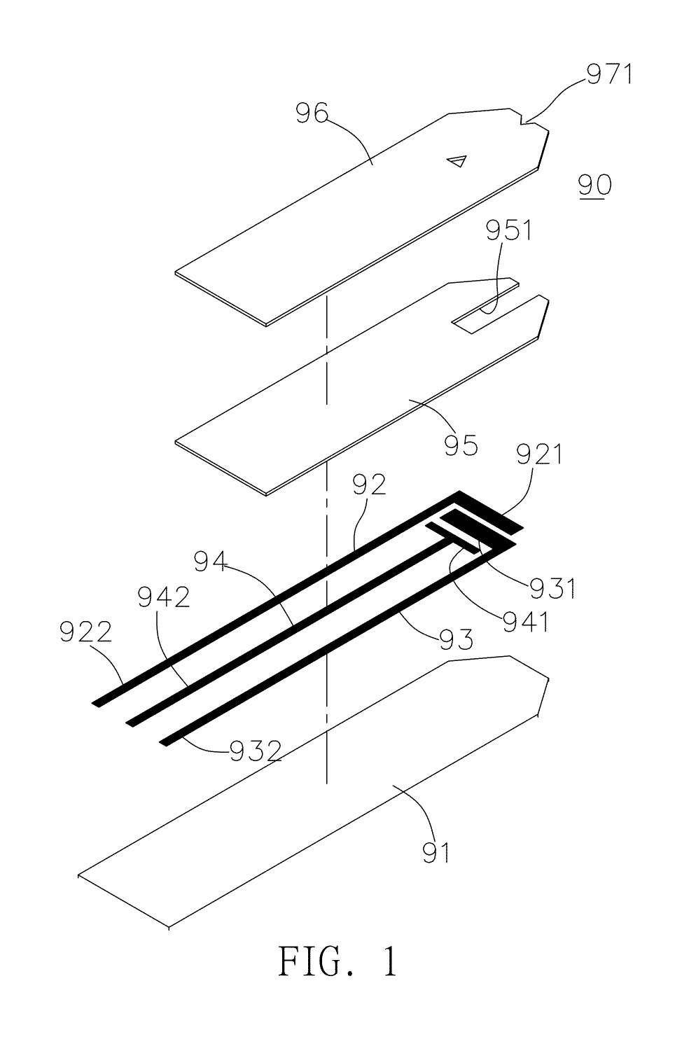

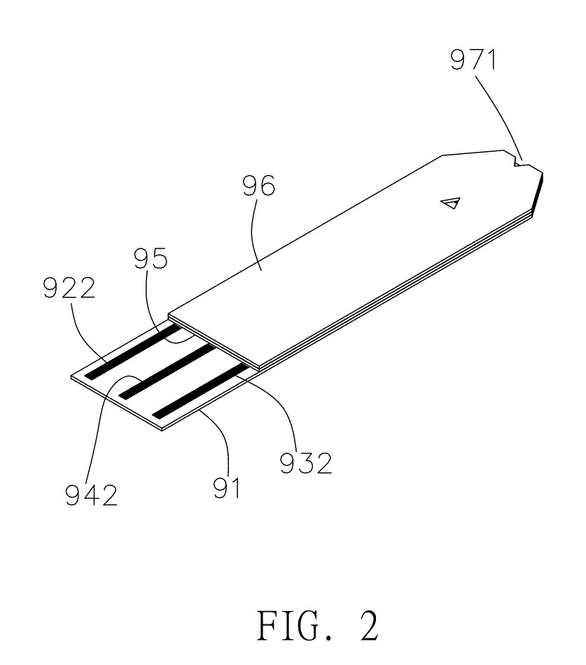

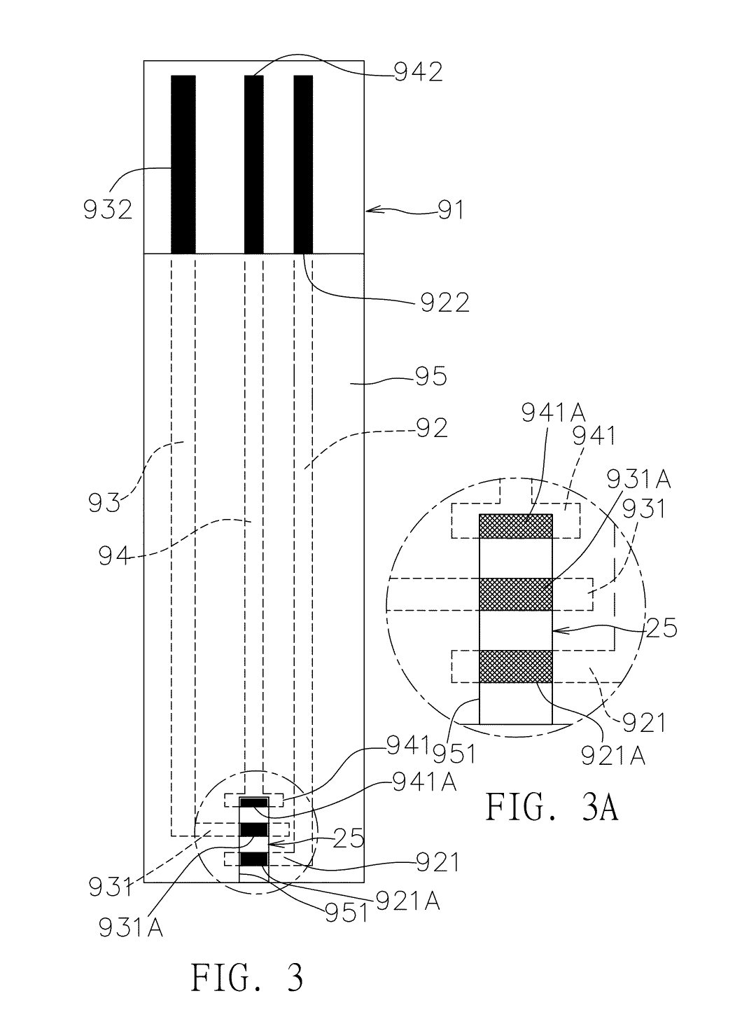

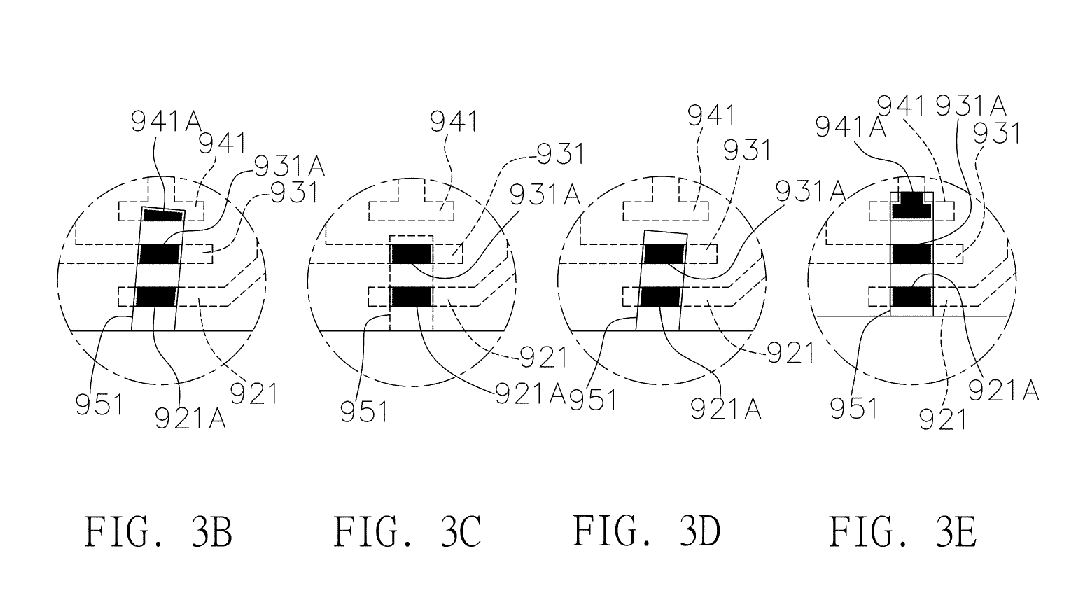

With reference to FIGS. 1 and 2 for the manufactured and assembled structure of a biosensor test strip of the present invention, the biosensor test strip as shown in FIG. 1 comprises a test strip 90; the test strip 90 comprises a substrate 91, a separating plate 95 and a cover plate 96; the separating plate 95 has a sensing window 951; the substrate 91 has three electrodes disposed thereon, the three electrodes proximate to a side of the sensing window, and the three electrodes sequentially arranged from the outside to the inside are a first electrode 92, a second electrode 93 and a third electrode 94; an end of the first electrode proximate to the sensing window is a first reacting electrode 921, an end of the second electrode proximate to the sensing window is a second reacting electrode 931, an end of the third electrode proximate to the sensing window is a third reacting electrode 941; the first reacting electrode 921, the second reacting electrode 931 and the third reacting electrode 941 form an electrode reaction area 25 (FIG. 3A); the other end of each electrode corresponsive to the electrode reaction area 25 is a first sensing electrode 922, a second sensing electrode 932, and a third sensing electrode 942; the separating plate 95 is attached onto the substrate 91 and covered onto the first electrode 92, the second electrode 93 and the third electrode 94, wherein the sensing window 951 is aligned with the first reacting electrode 921, the second reacting electrode 931 and the third reacting electrode 941; the length of the separating plate 95 allows the separating plate 95 to be exposed from the first sensing electrode 922, the second sensing electrode 932, or the third sensing electrode 942 when the separating plate 95 is attached onto the substrate 91; the cover plate 96 is covered onto the separating plate 95, the length of the cover plate 96 is equal to the length of the separating plate 95, the cover plate 96 has a guide opening 971 formed at a position corresponsive to the sensing window 951. When use, the test strip 90 is inserted into a testing instrument (such as a blood glucose meter, not shown in the figure), and then a sample (such as a blood or urine sample) is introduced through the guide opening 971, and then the sample is in contact with the first reacting electrode 921, the second reacting electrode 931 and the third reacting electrode 941, and the testing instrument is turned on to generate an electronic signal and produce a test result.

With reference to FIGS. 3 and 3A, after the separating plate 95 is attached onto the substrate 91, the first reacting electrode 921, the second reacting electrode 931 and the third reacting electrode 941 have a partial area exposed from the sensing window 951; the partial area of the first reacting electrode 921 exposed from the sensing window 951 is a first electrode reaction area 921A, the partial area of the second reacting electrode 931 exposed from the sensing window 951 is a second electrode reaction area 931A; the partial area of the third reacting electrode 941 exposed from the sensing window 951 is a third electrode reaction area 941A; the area exposed from first electrode reaction area 921A, the second electrode reaction area 931A and the third electrode reaction area 941A is a redox reaction area; the first electrode reaction area 921A and the third electrode reaction area 941A serve as a basis for testing the electrode reaction area of the present invention.

When the test strip 90 is used, the first electrode reaction area 921A (FIG. 3A), the second electrode reaction area 931A and the third electrode reaction area 941A carry the sample (or an object to be tested). According to the Cottrell equation, i(t)=K·n·F·A·C·D^{0.5}·t^{-0.5}, and the concentration C of the sample (or object to be tested) is directly proportional to the sensing current i, since the sensing current i is also directly proportional to the surface area A of the operating electrode, the surface area A of the operating electrode of an accurately defined test strip is a key factor to a precise measuring instruction. Taking the blood glucose test strip for example, we introduce the sample into the test strip 90 and apply a voltage, such that the first electrode reaction area 921A generates a first electrode reaction current 921C (not shown in the figure), and the third electrode reaction area 941A generates a third electrode reaction current 941C (not shown in the figure). Assumed that the first electrode reaction area 921A is A1, the first electrode reaction current 921C is C1, the third electrode reaction area 941A is A3, and the third electrode reaction current 941C is C3, the area ratio of the first electrode reaction area A1 to the third electrode reaction area A3 is equal to the first electrode reaction current C1 to the third electrode reaction current C3 (A1/A3=C1/C3=R). Through experiment statistics, a numeric value range is set in advance, such that when the value of R falls within the numeric value range, the first electrode reaction area 921A and the third electrode reaction area 941A are correct, and the attaching position of the separating plate 95 is correct, and the electrode reaction area of the test strip 90 is good product. On the other hand, when the value of R does not fall within the numeric value range, the first electrode reaction area 921A and the third electrode reaction area 941A are incorrect, and the attaching position of the separating plate 95 is incorrect, so that the electrode reaction area of the test strip is defective. The settings of aforementioned numeric value range varies with the type of samples, different biological test strips or different testing precision requirements.

With reference to FIG. 3B to 3E, if the attaching position of the separating plate 95 is incorrect, the first electrode reaction area 921A and the third electrode reaction area 941A displayed from the sensing window 951 will be changed, so that the value of R of A1/A3=C1/C3 will be changed and will not fall within the predetermined numeric value range, so that the electrode reaction area of the test strip is determined to be defective and incompliant with the precision requirement of the electrode area. The testing method of the invention allows us to discover the defective electrode reaction area of the test strip in advance to prevent the defective test strip product from being manufactured continuously, entering into the market, or generating a wrong testing value in a test or adjustment immediately in a test.

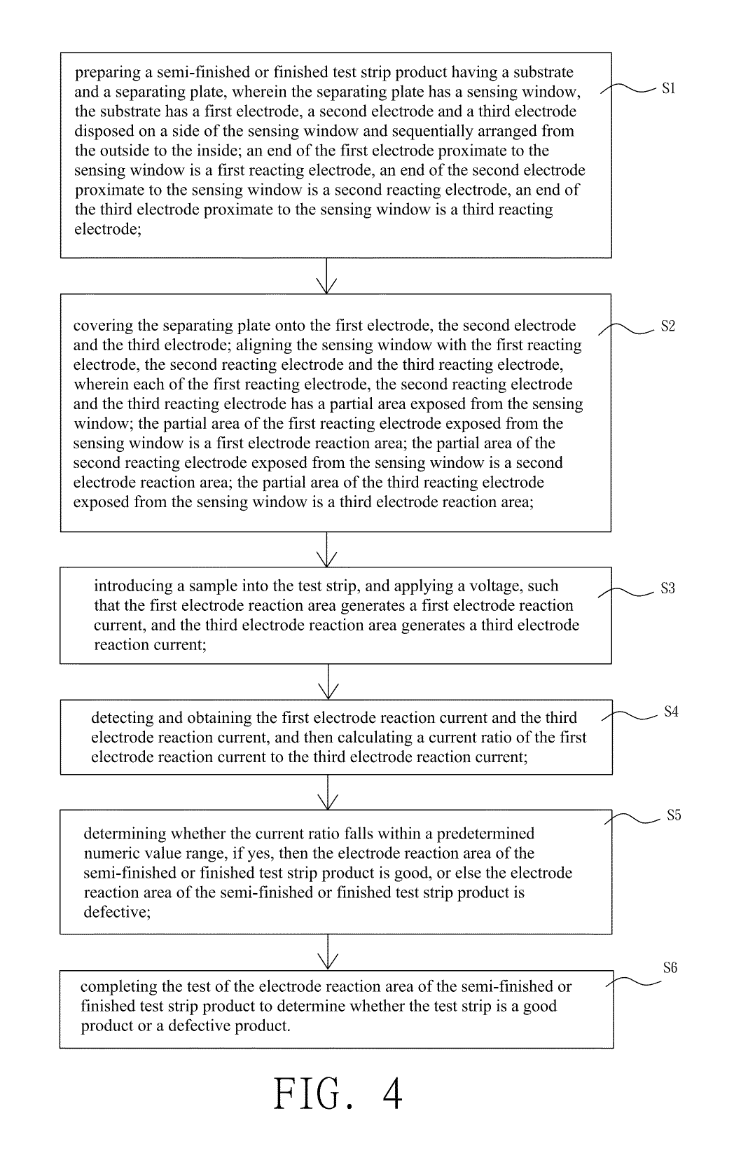

With reference to FIG. 4 and the aforementioned description of the electrode reaction area testing method of a biosensor test strip electrode in accordance with the present invention, the method comprises the following steps:

S1: Prepare a semi-finished or finished test strip product, wherein the semi-finished or finished test strip product comprises a substrate 91 and a separating plate 95, wherein the separating plate 95 has a sensing window 951, the substrate 91 has a first electrode 92, a second electrode 93 and a third electrode 94 disposed on a side of the sensing window 951 and sequentially arranged from the outside to the inside; an end of the first electrode 92 proximate to the sensing window 951 is a first reacting electrode 921, an end of the second electrode 93 proximate to the sensing window 951 is a second reacting electrode 931, an end of the third electrode 94 proximate to the sensing window 951 is a third reacting electrode 941.

S2: Cover the separating plate 95 onto the first electrode 92, the second electrode 93 and the third electrode 94, align the sensing window 951 with the first reacting electrode 921, the second reacting electrode 931 and the third reacting electrode 941, wherein each of the first reacting electrode 921, the second reacting electrode 931 and the third reacting electrode 941 has a partial area exposed from the sensing window 951; the partial area of the first reacting electrode 921 exposed from the sensing window 951 is a first electrode reaction area 921A, the partial area of the second reacting electrode 931 exposed from the sensing window 951 is a second electrode reaction area 931A, the partial area of the third reacting electrode 941 exposed from the sensing window 951 is a third electrode reaction area 941A.

S3: Introduce a sample into the semi-finished or finished test strip product, and apply a voltage, such that the first electrode reaction area 921A generates a first electrode reaction current 921C, and the third electrode reaction area 941A generates a third electrode reaction current 941C.

S4: Detect and obtain the first electrode reaction current 921C and the third electrode reaction current 941C, and then calculate a current ratio of the first electrode reaction current 921C to the third electrode reaction current 941C.

S5: Determine whether the current ratio falls within a predetermined numeric value range; if yes, then the electrode reaction area of the semi-finished or finished test strip product is good and the separating plate 95 attaching position or insulating position is correct, or else the electrode reaction area of the semi-finished or finished test strip product is defective and the separating plate 95 attaching position or insulating position is incorrect.

S6: Complete testing the electrode reaction area of the semi-finished or finished test strip product. to determine whether the test strip is a good product or a defective product.

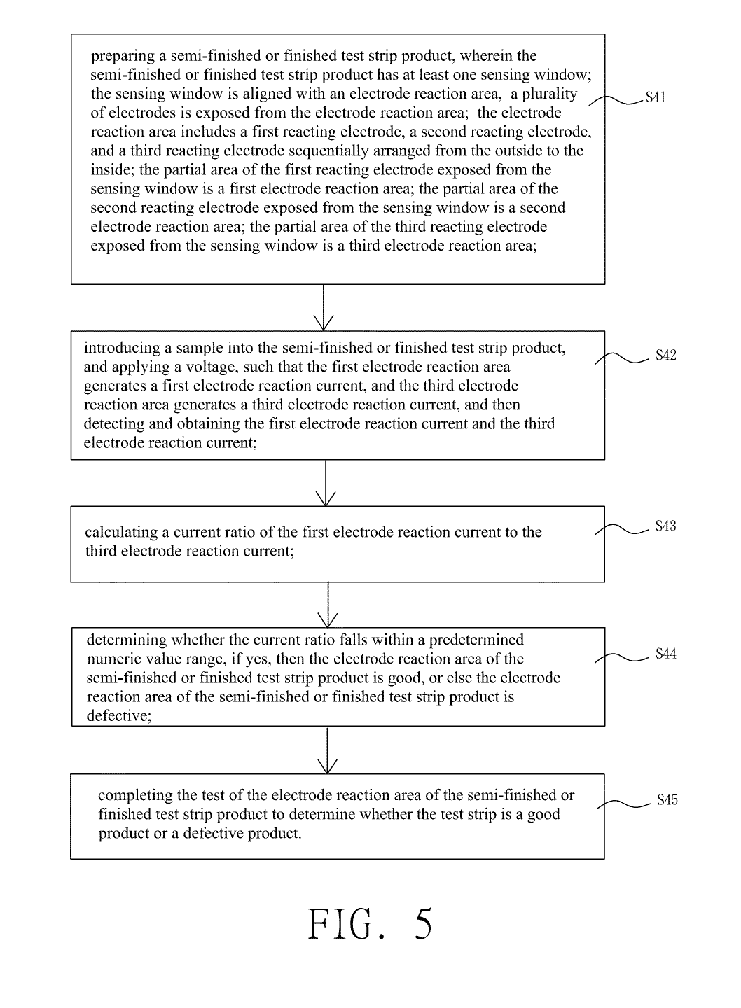

With reference to FIG. 5 and the aforementioned description of the electrode reaction area testing method of a biosensor test strip in accordance with the present invention, the method comprises the following steps:

S41: Prepare a semi-finished or finished test strip product, wherein the semi-finished or finished test strip product comprises at least one sensing window 951; the sensing window 951 is aligned with an electrode reaction area 25 (FIG. 3A), a plurality of electrodes is exposed from the electrode reaction area 25; the electrode reaction area 25 has a first reacting electrode 921, a second reacting electrode 931, a third reacting electrode 941 sequentially arranged from the outside to the inside; the partial area of the first reacting electrode 921 exposed from the sensing window 951 is a first electrode reaction area 921A; the partial area of the second reacting electrode 931 exposed from the sensing window is a second electrode reaction area 931A; the partial area of the third reacting electrode 941 exposed from the sensing window is a third electrode reaction area 941A.

S42: Introduce a sample into the semi-finished or finished test strip product, and apply a voltage such that the first electrode reaction area 921A generates a first electrode reaction current 921C, and the third electrode reaction area 941A generates a third electrode reaction current 941C, and then detect and obtain the first electrode reaction current 921C and the third electrode reaction current 941C.

S43: Calculate a current ratio of the first electrode reaction current 921C to the third electrode reaction current 941C by dividing the first electrode reaction current 921C by the third electrode reaction current 941C to obtain the current ratio (wherein the current ratio=the area ratio=921C/941C=921A/941A).

S44: Determine whether the current ratio falls within a predetermined numeric value range; if yes, then the electrode reaction area of the semi-finished or finished test strip product is good, or else the electrode reaction area of the semi-finished or finished test strip product is defective. Taking the blood glucose test strip for example, we determine whether the current ratio falls within a predetermined numeric value range; if yes, then the electrode reaction area of the semi-finished or finished test strip product is good, or else the electrode reaction area of the semi-finished or finished test strip product is defective, and such result ensures that the first electrode reaction area 921A and the third electrode reaction area 941A exposed from the sensing window 951 complies with the required standards. In other words, the separating plate attaching position or insulating position is correct.

S45: Complete testing the electrode reaction area of the semi-finished or finished test strip product to determine whether the test strip is a good product or a defective product.

In the electrode reaction area testing method of a biosensor test strip in accordance with the present invention, the accuracy of the separating plate attaching position or insulating position and the applicability of the electrode reaction area can be tested during the manufacture of the test strip to determine whether is test strip is a good product, so as to improve the quality of the test strip product and the accuracy of measuring physiological data.

What is claimed is:

1. An electrode reaction area testing method of biosensor test strip, comprising the steps of:
preparing a semi-finished or finished test strip product having a substrate and a separating plate, wherein the separating plate has a sensing window, the substrate has a first electrode, a second electrode and a third electrode disposed on a side of the sensing window and sequentially arranged from the outside to the inside; an end of the first electrode proximate to the sensing window is a first reacting electrode, an end of the second electrode proximate to the sensing window is a second reacting electrode, an end of the third electrode proximate to the sensing window is a third reacting electrode; covering the separating plate onto the first electrode, the second electrode and the third electrode; aligning the sensing window with the first reacting electrode, the second reacting electrode and the third reacting electrode, wherein each of the first reacting electrode, the second reacting electrode and the third reacting electrode has a partial area exposed from the sensing window; the partial area of the first reacting electrode exposed from the sensing window is a first electrode reaction area; the partial area of the second reacting electrode exposed from the sensing window is a second electrode reaction area; the partial area of the third reacting electrode exposed from the sensing window is a third electrode reaction area;
introducing a sample into the test strip, and applying a voltage, such that the first electrode reaction area generates a first electrode reaction current, and the third electrode reaction area generates a third electrode reaction current;
detecting and obtaining the first electrode reaction current and the third electrode reaction current, and then calculating a current ratio of the first electrode reaction current to the third electrode reaction current;
determining whether the current ratio falls within a predetermined numeric value range; if yes, then the electrode reaction area of the semi-finished or finished test strip product is good and the separating plate attaching position or insulating position is correct, or else the electrode reaction area of the semi-finished or finished test strip product is defective and the separating plate attaching position or insulating position is incorrect; and
completing the test of the electrode reaction area of the semi-finished or finished test strip product to determine whether the test strip is a good product or a defective product.

2. The electrode reaction area testing method of biosensor test strip according to claim 1, wherein the predetermined numeric value range is set by experiment statistics, such that when the current ratio falls within the numeric value range, the first electrode reaction area and the third electrode reaction area are correct.

3. An electrode reaction area testing method of biosensor test strip, comprising the steps of:
preparing a semi-finished or finished test strip product, wherein the semi-finished or finished test strip product has at least one sensing window; the sensing window is aligned with an electrode reaction area, a plurality of electrodes is exposed from the electrode reaction area; the electrode reaction area includes a first reacting electrode, a second reacting electrode, and a third reacting electrode sequentially arranged from the outside to the inside; the partial area of the first reacting electrode exposed from the sensing window is a first electrode reaction area; the partial area of the second reacting electrode exposed from the sensing window is a second electrode reaction area; the partial area of the third reacting electrode exposed from the sensing window is a third electrode reaction area;
introducing a sample into the semi-finished or finished test strip product, and applying a voltage, such that the first electrode reaction area generates a first electrode reaction current, and the third electrode reaction area generates a third electrode reaction current, and then detecting and obtaining the first electrode reaction current and the third electrode reaction current;
calculating a current ratio of the first electrode reaction current to the third electrode reaction current;
determining whether the current ratio falls within a predetermined numeric value range, if yes, then the electrode reaction area of the semi-finished or finished test strip product is good, or else the electrode reaction area of the semi-finished or finished test strip product is defective; and
completing the test of the electrode reaction area of the semi-finished or finished test strip product to determine whether the test strip is a good product or a defective product.

4. The electrode reaction area testing method of biosensor test strip according to claim 3, wherein the predetermined numeric value range is set by experiment statistics, and when the area ratio falls within the numeric value range, the first electrode reaction area and the third electrode reaction area are correct.
